(19) United States
(12) Patent Application Publication
(10) Pub. No.: US 2007/0053436 A1
(43) Pub. Date: Mar. 8, 2007

(54) Encoding video information using block based adaptive scan order

(75) Inventor: Lambertus Antonius Van Eggelen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., BA Eindhoven (NL)

(21) Appl. No.: 10/555,264

(22) PCT Filed: May 4, 2004
(86) PCT No.: PCT/IB04/50575

§ 371 Date: Nov. 1, 2005

(30) Foreign Application Priority Data
May 6, 2003 (EP) 03101245.3

(51) Int. Cl. H04N 11/04; H04N 7/12; H04B 1/66; H04N 11/02

(52) U.S. Cl. 375/240.24; 375/240.18

(57) ABSTRACT

There is described an encoder (100; 200; 300) for encoding input video information to provide corresponding encoded output data. The encoder (100; 200; 300) comprises: (a) an input for receiving the video information comprising data corresponding to a sequence of image frames (20); (b) first processing hardware (110) for subdividing the data associated with each frame (20) into a plurality of data macro blocks (30); (c) second processing hardware (110) for transforming data of each macro block (30) into a corresponding coefficient data block recording at least spatial information present in its associated macro block (30); (d) third processing hardware (110) for scanning according to a scanning route each coefficient data block to generate a corresponding rearranged data block; and (e) a data compressor (110) for applying data compression to the rearranged data blocks to generate the encoded output data. The third processing hardware (110) is operable to select automatically the scanning route in response to a degree of asymmetry in each coefficient block to enhance data compression of the video information present in the encoded output data. Moreover, the third processing hardware is operable to utilize only a single scanning route for processing each coefficient data block to generate its corresponding rearranged data block.

### FIELD OF THE INVENTION

The present invention relates to encoding video information, for example encoding video information in encoders and/or decoders associated with apparatus such as digital video disc (DVD) systems, digital televisions and video transmission systems. In particular, but not exclusively, the invention relates to encoding video information wherein selection of scanning route of encoding coefficients is utilized.

### BACKGROUND OF THE INVENTION

Methods of encoding image information, for example video signals and image data, are known and include standards such as International Telecommunications Union (ITM) ITU-T Recommendation H. 263+ and H. 263/L. Consequently, to address shortcomings associated with earlier methods of encoding image information, the International Standard MPEG-4 (Moving Pictures Expert Group) designation ISO/IEC 14496 was finalized in October 1998. Earlier MPEG standards are also presently in use, for example MPEG-1 and MPEG-2.

Most contemporary hybrid video information coding techniques each employ a first motion-compensated DPCM (differential pulse code modulation) procedure for receiving video information and converting the information to intermediate data, a second two-dimensional DCT (discrete cosine transform) procedure for converting spatial image information present in the intermediate data into corresponding representative coefficients, a third procedure for quantizing these DCT coefficients and a fourth VLC (variable length coding) procedure for compressing the quantized DCT coefficients to provide encoded output video information.

In U.S. Pat. No. 5,767,909, methods and associated apparatus are described for encoding digital video signals comprising video frames, the methods utilizing an adaptive scanning technique. The methods each involve employing a source coder for receiving a video signal comprising image frames to be encoded and generating data blocks corresponding to the frames, for computing sets of transform coefficients corresponding to the blocks, for quantizing the sets of coefficients and then for coding the quantized sets to generate output encoded data. Moreover, the methods are distinguished in that they employ a scanner for scanning sets of quantized transform coefficients for adaptively determining a scanning order for each image frame based on a number of quantized transform coefficients having non-zero value. Adaptive determination of scanning order is capable of yielding a reduction in the amount of encoded data generated by the encoder, namely an enhanced degree of video information compression.

### SUMMARY OF THE INVENTION

The inventor has appreciated that, although the methods described in the aforesaid published United States patent are susceptible to providing additional data compression, the methods are potentially complex and expensive to implement in practice when adapting contemporary video information encoding apparatus to provide more data compression, especially when several types of video input information are to be accommodated by such encoding apparatus.

It is thus an object of the invention to provide a method of encoding video information which is capable of yielding enhanced data compression and yet is susceptible to being incorporated into existing contemporary video encoding apparatus, for example video encoders and corresponding decoders conforming to MPEG video image encoding standards, with relatively minor modification thereto.

According to a first aspect of the present invention, there is provided a method of encoding input video information to provide corresponding encoded output data as claimed in the appended claim 1.

The invention is of advantage in that the method is capable of encoding video information with enhanced data compression whilst requiring minimal modification to contemporary encoders when implemented in association therewith.

Preferably, a determination of the asymmetry in each coefficient block controlling the scanning route in step (d) of the method is dependent upon at least one of:
utilization of frame interlacing in the input video information;
spatial scaling aspect ratio of one or more image frames present in the video information;
pulldown material being present in the data of one or more of the image frames;
one or more scanning routes utilized for processing preceding image frames in the video information;
a degree of temporal motion occurring in a series of the image frames; and
statistical data relating to earlier selected scanning routes and their associated data compression performance.

Utilization of such asymmetry indicators enables the method to adapt precisely to the nature of input video information and hence better optimize data compression applied thereto.

Preferably, field and frame macro modes of operation are provided in step (b) of the method, the field macro mode being operable to mutually isolate interlaced image frame line information according to their associated temporal instances to generate corresponding data blocks for transformation in step (c) of the method, and the frame macro mode being operable to maintain spatial correspondence between each image frame and its associated data macro blocks to generate corresponding data macro blocks for transformation in step (c) of the method. Utilization of these modes is capable of assisting the method employ a most appropriate scanning route for achieving enhanced data compression.

Preferably, the scanning route utilized in step (d) of the method for generating the rearranged data blocks is switchable for one or more of:
a plurality of image frames;
individual image frames; and
within each frame image.

By arranging for the scanning route to be switchable from frame-to-frame and even within frames, it is capable of enabling the method cope more effectively with input video data of rapidly changing format and hence achieve enhanced data compression thereof.

More preferably, the scanning route utilized is selected in response to a proportion of a plurality of image frames being of interlaced format relative a proportion thereof being of progressive format. Such a selection of scanning route is potentially straightforward to implement in practice.

Preferably, transformation of data of each macro block into a corresponding coefficient data block recording at least spatial information present in its associated macro block in step (c) of the method is implemented using a discrete cosine transform. Such a transform is capable of resulting in effective data compression, although it will be appreciated that other types of transform can be alternatively or additionally utilized in the method.

Preferably, the method is executable in one or more of digital hardware logic and software. Hardware implementation is potentially inexpensive to implement in practice, whereas a software implementation of the method is susceptible to straightforward updating when implemented in diverse locations, for example in remote domestic video apparatus.

According to a second aspect of the present invention, there is provided an encoder for encoding input video information to provide corresponding encoded output data as claimed in the appended claim 7.

According to a third aspect of the present invention, there is provided software executable to process video information to generate corresponding encoded output data according to the first aspect of the invention.

Preferably, the software is recorded on a data carrier.

According to a fourth aspect of the present invention, there is provided a decoder for decoding encoded output data generated using the method according to the first aspect of the present invention.

Preferably, the decoder is operable to apply an inverse of the method according to the first aspect of the invention to regenerate video information from corresponding encoded output data.

In a fifth aspect of the present invention, there is provided encoded output data generated using the method of the first aspect of the invention. Whereas signal format is capable of being regarded as inventive, data format is similarly so as data and signals have become regarded as synonymous.

Preferably, the encoded output data is recorded on a data carrier, for example a compact disc (CD) and/or a DVD disc.

It will be appreciated that features of the invention can be combined in any combination without departing from the scope of the invention.

### BRIEF DESCRIPTION OF THE DRAWINGS

Embodiments of the invention will now be described, by way of example only, with reference to the following diagrams, wherein:

FIG. 1 is a schematic representation of processing steps utilized in conventional MPEG image information encoding;

FIG. 2 is a schematic example of data macro block generation for interlaced images;

FIG. 3 is an illustration of symmetrical and asymmetrical coefficient block scanning routes for accommodating dissimilar image scaling resulting from generating data macro blocks in response to receiving consecutive frame and interlaced image information;

FIG. 4 is a schematic representation of a first encoder according to the invention for executing the method of the invention;

FIG. 5 is a schematic representation of a second encoder according to the invention for executing the method of the invention;

FIG. 6 is a schematic representation of a third encoder according to the invention for executing the method of the invention,

FIG. 7 is a schematic diagram of a pulldown detection function of the third encoder illustrated in FIG. 6; and

FIG. 8 is a schematic diagram of a filter of the third encoder illustrated in FIG. 6.

### DESCRIPTION OF PREFERRED EMBODIMENTS

In order to describe the present invention in context, a brief description of contemporary MPEG video information encoding will firstly herewith be provided.

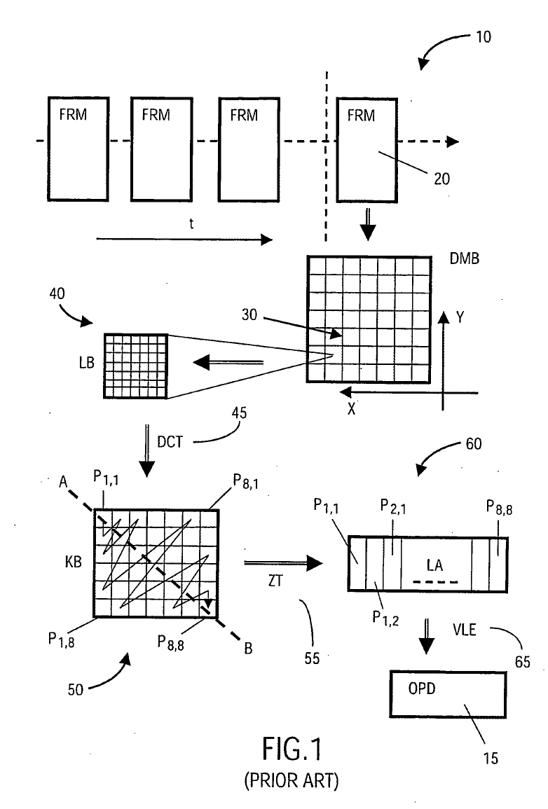

Referring to FIG. 1, there is shown processing steps implemented by a contemporary MWEG encoder when encoding image information; the steps are indicated generally by 10. In overview, the encoder receives a series of video image frames (FRM) in a temporal sequence t and processes them to provide corresponding MPEO encoded output data (OPD) denoted by 15.

Each received video frame FRM comprises a two-dimensional field of pixels which is subdivided within the encoder into data macro blocks DMB; conveniently, each macro block DMB comprises a two-dimensional 16×16 pixel field, although other field sizes are also feasible. For example, an image frame designated by 20 presently being processed within the encoder is subdivided into corresponding macro blocks DMB designated by 30.

The encoder further processes these macro blocks DMB, wherein each block DMB has generated for it four corresponding luminance data values and two corresponding chrominance data values which are stored in an associated luminance block LB designated by 40; for example, each luminance block LB conveniently comprises a two-dimensional 8×8 pixel field, although other field sizes are also feasible. The luminance data values include information concerning the brightness of each pixel in their corresponding macro block DMB; moreover, the chrominance data values include information pertaining to colour of each pixel in their corresponding macro block DMB.

The encoder applies a transform DCT denoted by 45 to each luminance block LB to derive a corresponding block of coefficients KB indicated by 50 describing spatial and colour information conveyed in the luminance block LB; conveniently, the coefficient blocks 17B are also each implemented as a two-dimensional 8×8 array, although other array sizes are feasible. Conventionally, the transform DCT employed is a discrete cosine transform (DCT), for example as described in MPEG standards, which is a complex mathematical procedure for providing spatial correlation. The transform DCT involves dividing each block LB pixel value by a larger integer, resulting in least significant bits being lost from each pixel; moreover, these values are simultaneously passed through a cosine function and finally summated as described in overview by Equation 1 (Eq. 1) as provided in a publication “Discrete Cosine Transform—Algorithms, Advantages, Applications” by K. R. Roa, P. Yip; Academic Press Inc. 1990:

$$F ( u , v ) = \frac{{C}_{u}}{2} \frac{{C}_{v}}{2} {\sum }_{y = 0}^{7} {\sum }_{x = 0}^{7} f ( x , y ) cos [ \frac{( 2 x + 1 ) u π}{16} ] cos [ \frac{( 2 y + 1 ) v π}{16} ] \qquad Eq . 1$$

wherein
Cᵤ=1/√2 if u=0;
Cᵤ=1 if u>0;
Cᵥ=1/√2 if v=0;
Cᵥ=1 if v>0;
x, y=block array indices;
f=a function,
   and other parameters of Equation 1 being defined in the aforementioned publication.

The coefficient blocks KB are then each subjected in the encoder to a processing operation ZT denoted by 55 which quantizes coefficients therein and then arranges these quantized coefficients into a corresponding one-dimensional block LA denoted by 60. The block LA is finally processed using a variable length coding (VLC) process denoted by 65 to generate the aforementioned encoded output data (OPD) 15. The VLC process 65 is conveniently implemented by a coding look-up table although other implementations are feasible.

The transform DCT is distinguished in that it generates coefficient blocks KB each comprising array elements P_{1,1}, P_{8,1}, P_{1,8} and P_{8,8} at top left-hand, top right-hand, bottom left-hand and bottom right-hand comers respectively as illustrated, wherein coefficients at the top left-hand corner are in operation of relatively greater magnitude in comparison to coefficients at the bottom right-hand comer. After quantization, many of the coefficients towards the bottom right-hand comer, namely approaching the element P_{8,8}, assume a zero value. Moreover, the processing operation ZT is operable to select quantized coefficient values in a “zig-zag” manner as illustrated when generating the block LA; such selection is capable of grouping zero-value coefficients together in the block LA so that the VLC process is capable of efficiently compressing information corresponding to zero-value coefficient groupings and including such compressed zero-value information in the output data OPD. In the operation ZT, the quantized coefficients are preferably selected in a sequence, namely a symmetrical scanning route, from P_{1,1} to P_{8,8} as follows:
P_{1,1} P_{2,1} P_{1,2} P_{1,3} P_{2,2} P_{3,1} P_{4,1} P_{3,2} P_{2,3} P_{1,4} P_{1,5} P_{2,4} P_{3,3} P_{2,4} P_{5,1} P_{6,1}
P_{5,2} P_{4,3} P_{3,4} P_{2,5} P_{1,6} P_{1,7} P_{2,6} P_{3,5} P_{4,4} P_{5,3} P_{6,2} P_{7,1} P_{8,1} P_{7,2} P_{6,3} P_{5,4}
P_{4,5} P_{3,6} P_{2,7} P_{1,8} P_{2,8} P_{3,7} P_{4,6} P_{5,5} P_{6,4} P_{7,3} P_{8,2} P_{8,3} P_{7,4} P_{6,5} P_{5,6} P_{4,7}
P_{3,8} P_{4,8} P_{5,7} P_{6,6} P_{7,5} P_{8,4} P_{8,5} P_{7,6} P_{6,7} P_{5,8} P_{6,8} P_{7,7} P_{8,6} P_{8,7} P_{7,8} P_{8,8}

It is a combination of the transform DCT, the symmetrical “zig-zag” scanning route of the operation ZT and the zero-value grouping characteristics of the VLC process which enables the MPEG processing steps 10 to provide useful video information compression.

The processing steps 10 are relatively straightforward to apply when video frames FRM are provided to the encoder in temporal sequence as described above, namely when progressive frame sequences are provided. However, when the video frames correspond to interlaced sequences, contemporary MPEG encoders include additional features to cope with interlaced image fields corresponding to mutually different temporal instances. Thus, in order to cope with interlaced images, the encoder is capable of operating in a frame macro mode when presented with progressive frame sequences, and in a field macro mode when provided with interlaced frame sequences.

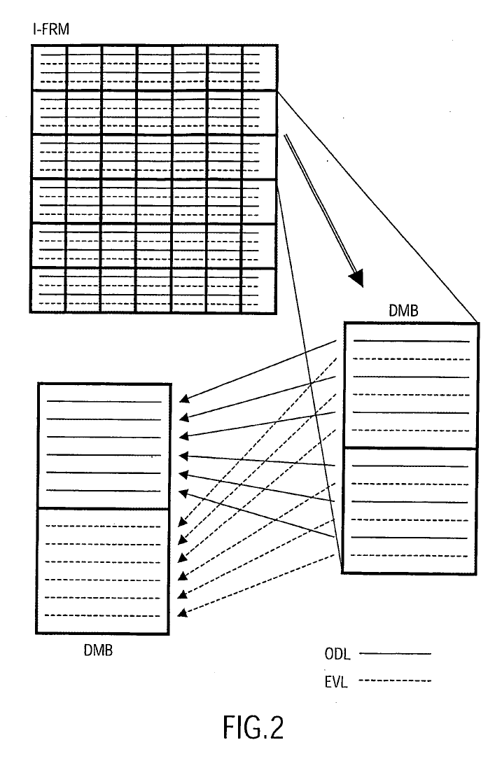

Interlaced frames comprise odd and even interlaced pixel lines where odd lines and even lines of a particular image frame occur at mutually different first and second time instances respectively. The encoder is capable in the field macro mode of processing the interlaced frames FRM into the data macro blocks DMB, for example for every macro block DMB, by isolating pixels of pairs of adjacent macro blocks corresponding to odd and even lines and assigning them to adjacent odd and even macro blocks as illustrated in FIG. 2. Such rearrangement of pixel lines introduces a vertical scaling change in the macro blocks DMB thereby generated from the scaled macro blocks.

The scaling change introduces a modification of spectral density generated in the coefficient blocks KB; namely, when scaling within the macro blocks DMB is similar in their two orthogonal spatial dimensions X, Y, coefficients within the corresponding coefficient blocks KB decrease substantially symmetrically from the top left-hand corner P_{1,1} to the bottom right-hand corner P_{8,8} along an axis A-B as illustrated. However, when scaling is dissimilar in the two orthogonal spatial dimensions X,Y of the coefficient macro blocks DMB, asymmetry of coefficient values in the corresponding blocks KB about their axis A-B consequently arises.

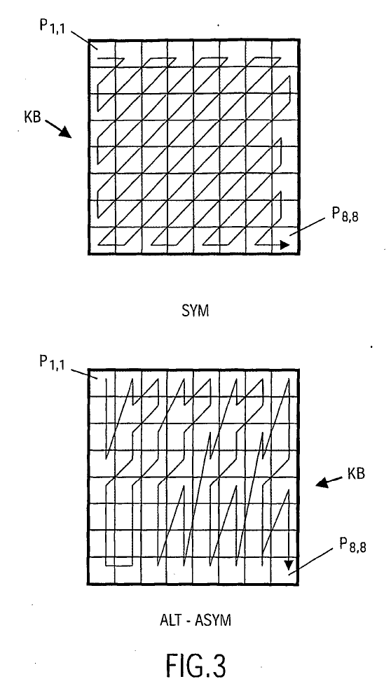

The symmetrical “zig-zag” selection of coefficients by the operation ZT depicted in FIG. 1 is only appropriate for optimal data compression when scaling is similar in the two orthogonal dimensions X, Y of the data macro blocks DMB. However, when the encoder functions in the field macro mode for processing interlaced image frames, an alternative asymmetrical scanning route provides optimal data compression as depicted in FIG. 3. In FIG. 3, the aforesaid “zig-zag” scanning route is also shown for comparison purposes. The alternative asymmetrical scanning route corresponds to a sequence from P_{1,1} to P_{8,8} as follows:
P_{1,1} P_{1,2} P_{1,3} P_{1,4} P_{2,1} P_{2,2} P_{3,1} P_{3,2} P_{2,3} P_{2,4} P_{1,5} P_{1,6} P_{1,7} P_{1,8} P_{2,8} P_{2,7}
P_{2,6} P_{2,5} P_{3,4} P_{3,3} P_{4,1} P_{4,2} P_{5,1} P_{5,2} P_{4,3} P_{4,4} P_{3,5} P_{3,6} P_{3,7} P_{3,8} P_{4,5} P_{4,6}
P_{4,7} P_{4,8} P_{5,3} P_{5,4} P_{6,1} P_{6,2} P_{7,1} P_{7,2} P_{6,3} P_{6,4} P_{5,5} P_{5,6} P_{5,7} P_{5,8} P_{6,5} P_{6,6}
P_{6,7} P_{6,8} P_{7,3} P_{7,4} P_{8,1} P_{8,2} P_{8,3} P_{8,4} P_{7,5} P_{7,6} P_{7,7} P_{7,8} P_{8,5} P_{8,6} P_{8,7} P_{8,8}

The inventor has appreciated that contemporary MPEG standards do not allow for the scanning route employed by the operation ZT to be automatically switchable between symmetrical and asymmetrical routes within an image frame FRM when processing macro blocks DMB. The MPEG standards allow for every data macro block DMB to be selectively chosen when switching from frame to field macro mode of operation, but maintain a scanning route adopted by the operation ZT constant within every image frame FRM.

Thus, the inventor has devised a method of encoding video information based on the processing steps 10 elucidated in the foregoing. In the inventor's method, there is utilized a predictor for optimal choice of scanning route for the operation ZT, the predictor being susceptible for example to straightforward incorporation into contemporary MPEG encoders at potentially low cost. Incorporation of such a predictor is capable of enhancing MPEG encoder video information compression by substantially 8% because the predictor allows for dynamic selection of scanning route when processing macro data blocks DMB from frame-to-frame and/or within an image frame FRM. In particular, the inventor has appreciated that it is practicable to re-use information provided by a field-frame DCT formatter, corresponding to the transform DCT and the operation ZT, which is incorporated into contemporary MPEG encoders for implementing the predictor and thereby dynamically modifying scanning route when encoding the frames FRM.

Moreover, the inventor has also envisaged that such an MPEG encoder including a predictor to enhance data compression is susceptible to being used in diverse apparatus such as DVD recorders capable of writing video information on compact discs (CD's) namely DVD+RW recorders, television set-top boxes, multimedia systems as well as computer software and professional MPEG encoders design for professional broadcast use to mention a few potential examples.

As elucidated in the foregoing, in contemporary low-cost MPEG encoders, implemented in one or more of software and hardware, a scanning route adopted by the operation ZT is user settable when commencing video stream encoding and is maintained unchanged during processing of the entire video stream. However, in some professional MPEG encoders, asymmetrical and symmetrical scanning routes for the operation ZT are both accommodated by simultaneously processing a plurality of video information streams, for example two video information streams, to generate corresponding output data OPD; a video stream providing most compressed output data is then selected in such professional encoders for generating the final output data OPD. Such simultaneous processing is expensive to implement because coefficient values from the coefficient block KB are processed a plurality of times.

The inventor has thus appreciated that it is feasible to adapt contemporary MPEG encoders operating according to the processing steps 10 to re-use information provided from a field/frame formatter employed in association therewith for generating the macro blocks DMB to estimate an optimum scanning route when processing the coefficient blocks KB to create the one-dimensional block LA.

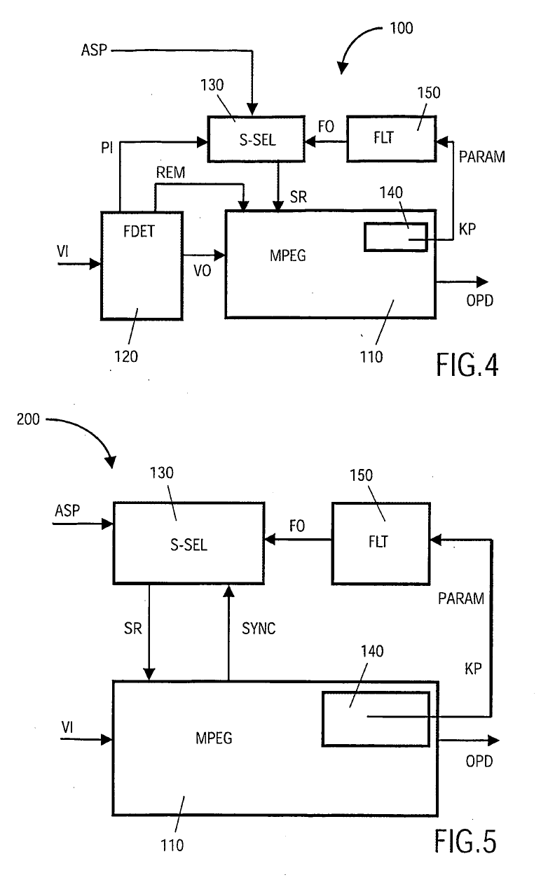

In the method of the invention, its field/frame formatter analyses each macro block DMB and determines therefrom an optimal DCT format for that macro block DMB. In consequence, when the field/frame formatter selects to code a macro block DMB in the aforementioned field macro mode, the operation ZT selects to employ an asymmetrical route for generating the block LA; in contradistinction, when the field/frame formatter selects to code a macro block DMB in the aforesaid frame macro mode, the operation ZT employs a substantially symmetrical route in generating the block LA. Most preferably, the selection of route is dynamically changeable within each image frame FRM being processed. Alternatively, the selection of scanning route can be made at commencement of processing of each frame FRM based on selected scanning route for one or more frames FRM temporally preceding thereto. In the following, encoders operating according to a method of the invention will be described with reference to FIGS. 4 to 8.

Referring firstly to FIG. 4, there is shown an encoder indicated generally by 100. The encoder 100 comprises a standard contemporary MPEG encoder (MPEG) 110, for example a contemporary MPEG-2 encoder. Coupled to the encoder 110 is a film detector (FDET) 120 including an input for receiving an incoming video information stream (VI) to be encoded and a first output (VO) for outputting the video stream to the encoder 110. The film detector 120 further includes a second output (PI) for indicating to a scanning route selector (S-SEL) 130 whether the incoming video information VI corresponds to progressive frames or to interlaced video information; the selector 130 is in turn connected via its SR output to the encoder 110 to determine a scanning route adopted by its operation ZT when processing coefficient blocks KB therein as described in the foregoing. Moreover, the detector 120 further includes a third output (REM) for indicating to the encoder 110 whether or not 2:3 pulldown material and/or 4:3 ratio material should be removed from the video information VO provided from the film detector 120 to the encoder 110. Additionally, an input aspect ratio (ASP) input is provided on the route selector 130 for use in determining scanning route selected by the operation ZT of the encoder 110; such selection of scanning route depending on input aspect ratio will be elucidated in greater detail later.

The encoder 110 also includes a first output from which its encoded output data (OPD) is provided. Additionally, the encoder 110 includes a second coding parameter output (KP) associated with an information collector 140 of the encoder 110 for outputting coding parameters to a filter 150 whose output (FO) is coupled to an input of the route selector 130 for assisting with selection of scanning route adopted for the operation ZT of the encoder 110.

Operation of the encoder 100 will now be described.

The video information VI flows into the detector 120 which analyses the information to determine whether or not it corresponds to interlaced image frames and whether or not it comprises 2:3 pulldown material and/or 4:3 ratio material. Moreover, the detector 120 also determines a scanning rate for the video information VI; the scanning rate is employed to set thresholds in the scanning route selector 130 for example. The detector 120 conveys corresponding analysis output to the route selector 130 and to the encoder 110 respectively. When the detector 120 detects interlaced incoming video information, it communicates via the route selector 130 to the encoder 110 that a substantially asymmetrical scanning route should be employed by the operation ZT of the encoder 110; conversely, when the detector 120 detectors progressive frame incoming video information and/or 2:3 pulldown video information and/or 4:3 pulldown video information, it communicates via the selector 130 to the encoder 110 that a substantially symmetrical scanning route should be employed by the operation ZT of the encoder 110. The encoder 110 is configure to remove 2:3 pulldown information when the third output REM of the detector 120 indicates that 2:3 pulldown material is present in the incoming video information stream VI. Preferably, the encoder 110 removes the 2:3 pulldown material in such a manner that a subsequent decoder compatible with the encoder 100 is capable of adding such material when decoding the output data (OPD) to reconstitute the input video information stream (VI).

The information collector 140 and its associated filter 150 are operable to control selection of scanning route for the operation ZT depending on, for example, a scanning route adopted for preceding image frames FRM.

The inventor has appreciated that the encoder 100 shown in FIG. 4 is susceptible to simplification where retention of 2:3 pulldown material can be tolerated in the output data (OPD). Such a simplified encoder is illustrated in FIG. 8; the simplified encoder is indicated generally by 200 therein. The encoder 200 is similar to the encoder 100 except that the frame detector 120 is omitted; moreover, a synchronization output (SYNC) is provided from the encoder 110 to the selector 130 to assist with frame synchronization. The encoder 200 is especially advantageous in that it is capable of selecting optimal scanning routes for the operation ZT in the encoder 110 whilst providing the benefit of being implementable using a standard contemporary MPEG encoder with relatively minimal modification thereto.

The encoders 100, 200 have been characterised in practice and found to provide substantially similar encoding performance and robustness. In both encoders 100, 200 investigated, the filter 150 and the selector 130 therein were implemented to modify a scanning route adopted in the operation ZT at commencement of a group of picture image frames (GOP). However, the inventor envisages that further enhanced compression is achievable by modifying the encoders 100, 200 so that their selector 130 is operable to alter scanning route on an image frame-by-image frame basis and, if desired, within each frame image FRM during image processing in the encoders 100, 200.

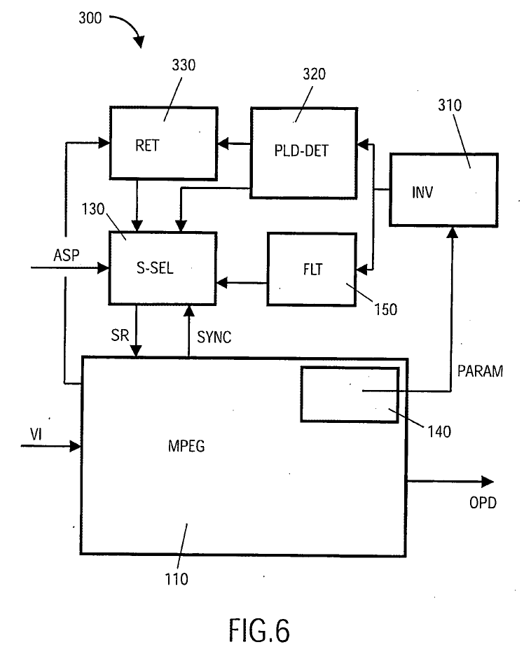

A drawback arises when the encoder 200 is configured so that its filter 150 averages over a sequences of frames FRM when directing the selector 130 to cause the encoder 110 to adopt a particular scanning route for its operation ZT. For example, the encoder 200 would then consequently adopt a constant scanning route for its operation ZT over the sequence where the sequence includes some 2:3 pulldown material and/or 4:3 ratio material in part thereof. Depending on a threshold value adopted for selecting between substantially symmetrical and asymmetrical scanning routes in the operation ZT, the entire sequence of images is then in this example encoded using a particular selected scanning route. In order to address reduction in data compression arising from adoption of such a constant scanning route, the encoder 200 can be further adapted to provide an encoder as illustrated schematically in FIG. 6 and indicated by 300 therein for efficiently coping with 2:3 pulldown material.

Configuration of the encoder 300 will firstly be described with reference to FIG. 6.

The encoder 300 is similar to the encoder 200 except that it additionally includes an inverse encoding reorder function (INV) 310, a pulldown detection function (PLD-DET) 320 and a timer function (RET) 330. The reorder function 310 is operable to receive coding parameters (PARAM) from the information collector 140 and processing them to provide corresponding data to the pulldown function 320 and to the filter 150. Moreover, the pulldown detection function 320 is arranged to output data to the timer function 330 and directly to the selector 130. Furthermore, the filter 150 is arranged to output data directly to the selector 130. Thus, the selector 130 is in turn operable to direct scanning route adopted by the operation ZT of the encoder 110 depending upon one or more of rate of motion within consecutive image frames present in the video information stream VI, whether or not pulldown material is present therein, and general characteristics of the coding parameters passed by the filter 150. The information collector 140 itself is interconnected within the encoder 110 to gather indicators of encoder 110 encoding performance, for example with regard to macro block DMB processing.

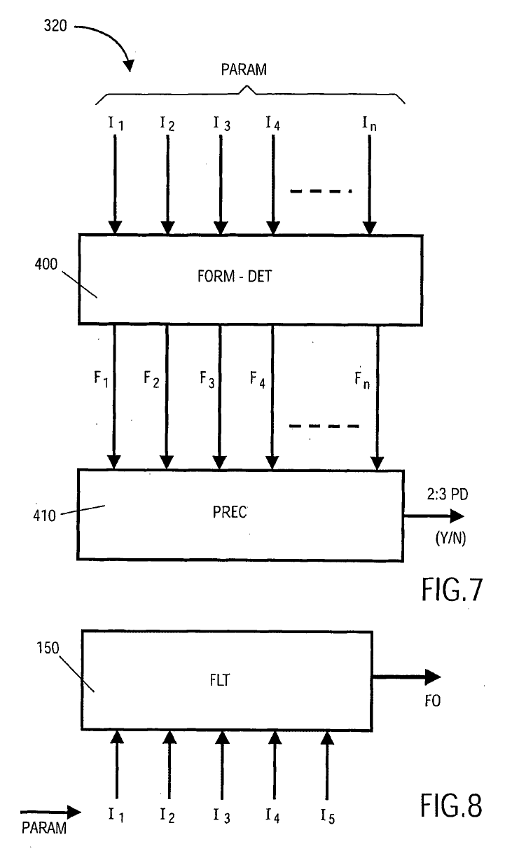

The pulldown function 320 is susceptible to being implemented as shown schematically in FIG. 7 by a combination of a form detector (FORM-DET) 400 and a pattern recognition detector (PREC) 410 coupled thereto. Information streams I₁ to Iₙ collected from the information collector 140 of the encoder 110 are processed by the form detector 400 to determine per image flame based on the coding parameters PARAM whether each image frame FRM is interlaced or temporally progressive. Output streams F₁ to Fₙ are indicative of frame format. The output streams F are communicated to the recognition detector 410 which determines whether or not the input video information VI includes 2:3 pulldovn material (2:3 PD), namely yes/no (Y/N) indication of the presence of such material.

Similarly, the filter 150 is susceptible to being implemented as illustrated in FIG. 8 wherein parameters I₁ to I₅ pertain to information collected by the information collector 140 indicative of the number of macro blocks coded in the encoder 300 functioning in one or more of the aforesaid macro modes, for example field macro mode and/or frame macro mode.

The encoder 300 is of advantage in that it is capable of detecting the presence of 2:3 pulldown material and phase from coding parameters provided from the information collector 140 and hence detecting motion within image frames FRM when operating in aforesaid field macro mode; when substantially low degrees of motion are present in the image frames FRM provided to the encoder 300, interlaced images are substantially similar and the substantially symmetrical scanning route for the operation ZT of the encoder 110 of the encoder 300 is then beneficially adopted to achieve efficient data compression in the output data OPD; conversely, when relatively high degrees of motion are present in the image frames, the asymmetrical scanning route for the operation ZT is then beneficially employed to achieve enhanced data compression in the output data OPD. When the detector 120 detects 2:3 pulldown video information with considerable motion, the asymmetrical scanning route for the operation ZT is beneficially employed.

The encoders 100, 200, 300 are preferably configured so that, when their encoder 110 is operating in field macro mode, a count is made of the number of macro blocks (DMB's) during n GOPs, namely where GOP and n correspond to “groups of image pictures” and an integer respectively; when commencement of processing of a new subsequent GOP occurs in the encoders 100, 200, 300, the encoders 100, 200, 300 are arranged to employ an asymmetrical scan route for their operation ZT when more than substantially 10% of the macro blocks DMB are processed to cope with interlacing, namely as in the field macro mode. When less than substantially 10% of the macro blocks DMB are processed to cope with interlacing, commencement of processing of a new subsequent GOP occurs with the encoder 110 of the encoders 100, 200, 300 arranged to employ a substantially symmetrical scan route for its operation ZP, for example a symmetrical “zig-zag” route as described in the foregoing.

Although a threshold of 10% is described above, it will be appreciated that other thresholds can be adopted, for example one or more thresholds in a range of 2% to 50%, and more preferably in a range of 5% to 25%.

It will further be appreciated that aspect ratio thresholds can be set within the encoders 100, 200, 300 such that certain aspect ratios of image frames present in the incoming video information, for example as communicated to the ASP input, result in the selector 130 causing the encoder 110 to adopt one or more preferred scanning routes in the operation ZT to achieve enhanced video information compression. For example, for 4:3 and 16:9 image frame aspect ratios, the encoder 110 is preferably capable of adopting two mutually different asymmetrical scanning routes for its operation ZT, such different scanning routes preferably optimized for such aspect ratios. Suitable scanning routes appropriate for various image aspect ratios can be determined in advance by suitable statistical analysis when programming and/or designing the encoders; alternatively, or additional, the scanning routes can be determined experimentally by characterizing a variety of scanning routes of various image aspect ratios whilst monitoring compression performance of the encoders 100, 200, 300.

The encoders 100, 200, 300 can be adapted so that their information collector 140 is operable to count the number of bits used to code the KB coefficients in processing n GOPs. When processing of a new GOP is commenced, the selector 130 is then directed to cause the operation ZT to utilize an asymmetrical scanning route when more than substantially 19% of the counted bits are used in connection with processing macro blocks DMBs in field macro mode. When substantially 19% or less counted bits are used in connection with processing macro blocks DMBs in field macro mode, the selector 130 is operable to cause the operation ZT to follow a symmetrical scanning route. Such a bit counting procedure for determining-scanning route for the operation ZT is advantageous in practice to control operation of the encoders 100, 200, 300 to achieve enhanced data compression therein. Although a threshold of substantially 19% is described above, it will be appreciated that the threshold can be modified if desired, for example in a range of 10% to 40%.

The encoders 100, 200, 300 are preferably implemented using encoding hardware, for example one or more application specific integrated circuits (ASIC) or one or more custom integrated circuits. Alternatively, the encoders 100, 200, 300 can be implemented in software susceptible to execution on computing hardware, for example a proprietary computing platform. As a yet further alternative, the encoders 100, 200, 300 can be implemented in a hybrid form as a combination of customized hardware and software with associated computing hardware. Similar implementation considerations pertain to complementary decoders employed to decode the output data OPD generated by the encoders 100, 200, 300; such decoders are also within the scope of the present invention and are preferably operable to perform a data processing function corresponding to an inverse of the encoding method utilized within the encoders 100, 200, 300.

It will be appreciated that other embodiments of the encoders 100, 200, 300 are practicable within the scope of the invention. Similarly, decoders suitable for decoding encoded video information from such other encoders and the encoders 100, 200, 300 are also within the scope of the present invention. The method of the present invention, apparatus implementing the method and software implementing the method are within the scope of the invention. The method is capable of providing enhanced data compression at potentially relatively low cost and therefore is industrially applicable in, for example, manufactured video encoding and/or decoding equipment.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of encoding input video information to provide corresponding encoded output data, the method comprising the steps of:
(a) receiving the video information comprising data corresponding to a sequence of image frames (20);
(b) subdividing the data associated with each frame into a plurality of data blocks (30);
(c) transforming (45) data of each data block into a corresponding coefficient data block (50) recording at least spatial information present in its associated data block;
(d) scanning (55) according to a scanning route each coefficient data block (50) to generate a corresponding rearranged data block (60);
(e) applying data compression (65) to the rearranged data blocks (60) to generate the encoded output data (15),
the method being operable in step (d) (55) to select automatically the scanning route in response to a degree of asymmetry in each coefficient block (50) to enhance data compression of the video information present in the encoded output data (15), and wherein in step (d) (55) only a single scanning route is utilized for processing each coefficient data block (50) to generate its corresponding rearranged data block (60).

2. A method according to claim 1, wherein a determination of the asymmetry in each coefficient block controlling the scanning route in step (d) is dependent upon at least one of:
utilization of frame interlacing in the input video information;
spatial scaling aspect ratio of one or more image frames present in the video information;
pulldown material being present in the data of one or more of the image frames;
one or more scanning routes utilized for processing preceding image frames in the video information;
a degree of temporal motion occurring in a series of the image frames; and
statistical data relating to earlier selected scanning routes and their associated data compression performance.

3. A method according to claim 1, wherein field and frame macro modes of operation are provided in step (b), the field macro mode being operable to mutually isolate interlaced image frame line information according to their associated temporal instances to generate corresponding data blocks for transformation in step (c), and the frame macro mode being operable to maintain spatial correspondence between each image frame and its associated data blocks to generate corresponding data macro blocks for transformation in step (c).

4. A method according to claim 1, wherein the scanning route utilized in step (d) for generating the rearranged data blocks is switchable for one or more of:
a plurality of image frames;
individual image frames; and
within each frame image.

5. A method according to claim 4, wherein the scanning route utilized is selected in response to a proportion of a plurality of image frames being of interlaced format relative a proportion thereof being of progressive format.

6. A method according to claim 1, wherein transformation of data of each macro block into a corresponding coefficient data block recording at least spatial information present in its associated data block in step (c) is implemented using a discrete cosine transform.

7. An encoder (100; 200; 300) for encoding input video information to provide corresponding encoded output data, the encoder (100; 200; 300) comprising:
(a) inputting means for receiving the video information comprising data corresponding to a sequence of image frames (20);
(b) first processing (110) means for subdividing the data associated with each frame (20) into a plurality of data blocks (30);
(c) second processing means (110) for transforming data of each data block (30) into a corresponding coefficient data block recording at least spatial information present in its associated data block (30);
(d) third processing means (110) for scanning according to a scanning route each coefficient data block to generate a corresponding rearranged data block;
(e) compressing means (110) for applying data compression to the rearranged data blocks to generate the encoded output data,
the third processing means (110) being operable to select automatically the scanning route in response to a degree of asymmetry in each coefficient block to enhance data compression of the video information present in the encoded output data, and wherein the third processing means is operable to utilize only a single scanning route for processing each coefficient data block to generate its corresponding rearranged data block.

8. Software executable to process video information to generate corresponding encoded output data according to the method of claim 1.

9. Encoded output data generated using the method of claim 1.

10. A data carrier having stored thereon encoded output data as claimed in claim 9.
